(19) United States
(12) Patent Application Publication
(10) Pub. No.: US 2012/0058225 A1
(43) Pub. Date: Mar. 8, 2012

(54) PROBIOTIC OIL SUSPENSION AND USE THEREOF

(75) Inventors: Vygantas Kirejevas, Tallinn (EE); Aram Kazarjan, Tallinn (EE)

(73) Assignee: BACTERFIELD OÜ, Tallinn (EE)

(21) Appl. No.: 13/265,320

(22) PCT Filed: Apr. 22, 2010
(86) PCT No.: PCT/EP2010/055353

§ 371 Date: Nov. 14, 2011

(30) Foreign Application Priority Data
Apr. 23, 2009 (EP) 09158592.7

(51) Int. Cl. A23K 1/16; A23L 1/30

(52) U.S. Cl. 426/61

(57) ABSTRACT

The present invention provides probiotic/oil suspension for vacuum infusion of an extruded probiotic food product characterized by balancing the requirements of a high concentration of the probiotic micro-organism in the suspension and physical properties that makes the suspension applicable for vacuum infusion. Further provided are methods of preparing said suspension and use thereof in the manufacture of an extruded probiotic food product.

### TECHNICAL FIELD OF THE INVENTION

The present invention relates to the provision of a probiotic/oil suspension for vacuum infusion of an extruded probiotic food product. Further, the invention relates to a method of preparing the probiotic/oil suspension. Finally, the invention relates to a method of using the probiotic/oil suspension in the manufacturing of extruded probiotic food product and the extruded probiotic food product obtainable by the method.

### BACKGROUND OF THE INVENTION

Various commercial attempts have been made to achieve food compositions containing probiotic micro-organisms with prolonged viability for long term storage, many of these do not provide sufficient efficacious levels of viable probiotic micro-organism due to issues associated with susceptibility of the micro-organism to standard commercial pet food manufacturing procedures such as extrusion. For example, efforts of coating or filling standard pet food kibbles with probiotic micro-organisms have been suggested but, in practice, often prove impractical.

WO 01/95745 provides a method of producing a food product (kibbles) characterised by a porous structure, comprising an instable substrate such as a probiotic micro-organism in an oil solution, which are included in a flowable form into the product by means of a step of “partial vacuum” followed by normalizing the pressure by releasing an inert gas into the vessel.

WO 05/070232 provides a method of producing a food product similar to WO 01/95745, further characterized in that the oil should have a solid fat index of at least 20. WO 05/070232 discloses the essential use of fat with the solid fat index of the vehicle is at least 20 at 20° C. and the preferred vehicle are coconut oil and even more preferred palm oil.

WO 03/009710 discloses system and method for on-line mixing and application of surface coating compositions for food products; an apparatus is also disclosed. The apparatus comprises a dry matter—liquid mixing module (wherein the dry matter may be probiotics) connected inline to a liquid—liquid mixing module, wherein one or more liquid can be mixed into the first liquid (potentially comprising the probiotics).

### SUMMARY OF THE INVENTION

Thus, an object of the present invention relates to the provision of probiotic/oil suspension for vacuum infusion of an extruded probiotic food product characterized by balancing the requirements of a high concentration of the probiotic micro-organism in the suspension and physical properties that makes the suspension applicable for vacuum infusion.

Thus, one aspect of the invention relates to a suspension for vacuum infusion of an extruded probiotic food product, wherein said suspension comprises an oil and at least one probiotic micro-organism in the concentration of 10⁶-10¹⁶ CFU/kg of said oil, and said suspension having a dynamic viscosity of less than 0.08 pascal-second (Pa·s)at 20° C.

In an alternative aspect the invention relates to a suspension for vacuum infusion of an extruded probiotic food product, wherein said suspension comprises an oil and at least one probiotic micro-organism in the concentration of 10⁶-10¹⁶ CFU/kg of said oil, and wherein said oil having a dynamic viscosity of less than 0.08 pascal-second (Pa·s) at 20° C.

The suspension of the invention is adapted to the vacuum infusion process by selecting suitable components for the suspension and balancing the components in the suspension to obtain a suspension suitable for application of the suspension on the food product by spraying the suspension on the product under vacuum.

Another aspect of the present invention relates to a method of preparing a suspension of the invention, said method comprising:
a) providing at least one probiotic micro-organism in a dry powder form having a total concentration of 10⁹-10¹⁷ CFU/kg dry powder
b) providing an oil
c) adding 0.3 to 15 kg of said probiotic micro-organism powder per 100 kg oil to said oil in an container at continuously stirring at RT to make a suspension premix
d) transferring the suspension premix of c) to a storage tank comprising mixing means with the proviso that the transfer is not by vacuum suction
e) mixing said premix suspension RT to obtain a suspension of homogenously dispersed probiotic micro-organism
   and obtaining said suspension.

Yet another aspect of the present invention is to provide a method of producing an extruded food product comprising at least one probiotic micro-organism, wherein said probiotic micro-organism is homogenously distributed throughout the structure of the food by vacuum inclusion of the suspension of the invention.

Still another aspect of the present invention is to provide an extruded probiotic food product obtained by said method of producing an extruded food product.

A final aspect of the present invention relates to use of the suspension of the invention for the preparation of a extruded probiotic food product, wherein said suspension comprises an oil and at least one probiotic micro-organism in the concentration of 10⁷-10¹⁷ CFU/kg of said oil and said suspension having a dynamic viscosity of less than 0.08 pascal-second (Pa·s)at 20° C.

### BRIEF DESCRIPTION OF THE FIGURES

FIG. 1

Table 1. Viscosity of selected oil types vs temperature. The viscosity was measured using a rheometer. Delta viscosity between 20° C. and 25° C. is indicated.

For further details see Example 1.

FIG. 2

The figure displays the viscosity of selected oil types versus temperature within the temperature interval of 20-25° C. 1: Crude fish oil, 2: Salmon oil A, 4: Cod liver oil, 5: Salmon oil B. For further details see Example 1.

FIG. 3

FIG. 3 shows one embodiment of the invention illustrating tanks, vessels connections and the like which may form part of the production plant according to the invention.

FIG. 4

FIG. 4 shows the viscosity of selected oil types versus temperature within the temperature interval of 20-25° C.

FIG. 5

FIG. 5 shows the viscosity of selected vegetable oil types versus temperature within the temperature interval of 20-25° C.

FIG. 6

FIG. 6 shows the viscosity of linseed oil versus temperature within the temperature interval of 15-35° C.

FIG. 7

FIG. 7 shows the viscosity of salmon oil A with (susp) or without (raw oil). Suspension comprises probiotics at a concentration/inclusion rate 1.2 kg/ton of final product. Data are shown for an increasing temperature from 5 to 50° C. (arrow pointing to the right) and for a decreasing temperature from 50 to 5° C. (arrow pointing to the left). Exact data points are indicated in FIG. 1 (see also example 5).

In the following sections the inventions will be discussed in further detail.

The present invention will now be described in more detail in the following.

### DETAILED DESCRIPTION OF THE INVENTION

### Definitions

Prior to discussing the present invention in further details, the following terms and conventions will first be defined:

### Suspension

Suspension refers to a fluid (such as an oil) containing particles that will not dissolve in the fluid and are sufficiently large for sedimentation such as freeze dried micro-organisms. A homogenous suspension refers to a suspension, wherein the particles are dispersed throughout the external phase (the fluid) through mechanical agitation (such as mixing). The suspended particles (e.g. micro-organisms) are visible under a microscope and will settle over time if left undisturbed.

### Oil

In the context of the present invention the term “oil” refers to any edible vegetable and/or animal oils. Oil in the context of the present invention is in a viscous liquid state (“oily”) at room temperature. Oil includes “fatty acids”, which are carboxylic acids often with a long un-branched aliphatic tail (chain), which is either saturated or unsaturated (such as monounsaturated or polyunsaturated). The ratio of saturated to unsaturated fatty acids varies among oils. For example, flaxseed oil comprises 9% of saturated fatty acids, 18% mono-unsaturated fatty acids, and 73% of polyunsaturated fatty acids. In contrast, coconut oil comprise 91% saturated fatty acids, 7% mono-unsaturated fatty acids, and 2% poly-unsaturated fatty acids. For dietary application, oils rich in unsaturated fatty acids are highly preferred due to the health benefits of the unsaturated fatty acids over the saturated fatty acids. Thus, in order to sustain the key health benefits and features of the food product, the products described in this invention preferably comprises a high level of unsaturated fatty acids. Fish oils fall within the definition of oil. Fish oils include but are not limited to salmon oil, mackerel oil, lake trout oil, herring oil, sardine oil, albacore tuna oil, cod liver oil, sand eel oil (Ammodytes tobianus), and menhaden oil.

Omega-3 fatty acids

The term “omega-3 fatty acids” are a family of unsaturated fatty acids that have in common a final carbon-carbon double bond in the n-3 position; that is, the third bond from the methyl end of the fatty acid. Examples of important nutritionally essential omega-3 fatty acids are α-linolenic acid (ALA), eicosapentaenoic acid (EPA), and docosahexaenoic acid (DHA).

### Omega-6 Fatty Acids

The term “omega-6 fatty acids” are a family of unsaturated fatty acids which have in common a final carbon-carbon double bond in the n-6 position; that is, the sixth bond from the end of the fatty acid. Examples of omega-6 fatty acids are linoleic acid and arachidonic acid.

### Vehicle

“Vehicle” or “carrier” refer to a fluid component (such as an oil) that carries at least one substance. In the context of the present invention an oil is used as vehicle for vacuum infusion of at least one probiotic micro-organism into an extruded food product. The vehicle may have the additional function of preserving the at least one probiotic micro-organism embedded in the extruded food product.

Accordingly, at least one oil used by the present invention functions as vehicle for infusion of probiotic micro-organisms in the manufacturing of an extruded food product. The manufacturing is performed at room temperature in order to optimize the probiotic count (CFU) in the final food product. In this respect the viscosity properties of the oil (e.g. dynamic viscosity) influence whether or not the oil is suitable for the vacuum infusion of the food product. Oils having an optimal viscosity at a temperature above room temperature may not be applicable at room temperature due to the change in viscosity.

### Viscosity

The term “viscosity” refers a measure of the resistance of a fluid which is being deformed by either shear stress or extensional stress. In everyday terms (and for fluids only), viscosity is “thickness”. The coefficient of viscosity is most often used as a value for viscosity. The shear viscosity and dynamic viscosity are most frequently used. “Dynamic viscosity” (or absolute viscosity) is a unit of measuring viscosity. The SI physical unit of dynamic viscosity is the pascal-second (Pa·s), which is identical to kg·m⁻¹·s⁻¹. If a fluid with a viscosity of one Pa·s is placed between two plates, and one plate is pushed sideways with a shear stress of one pascal, it moves a distance equal to the thickness of the layer between the plates in one second. The cgs physical unit for dynamic viscosity is the poise. It is more commonly expressed, particularly in ASTM standards, as centipoise (cP). The relation between poise and pascal-seconds is: 1 cP=0.001 Pa·s=1 mPa·s. Water at 20° C. has a viscosity of 1.0020 cP. Dynamic viscosity is measured with various types of rheometer, for example Physica MCR 301 as used in Example 1. The temperature dependence of the viscosity of the fluid is the phenomenon by which fluid viscosity generally decrease (or, alternatively, its fluidity generally increases) as its temperature increases. Thus, close temperature control of the fluid is essential to accurate measurements, particularly in materials like lubricants, whose viscosity can double with a change of only 5° C. The dynamic viscosity referred to in the context of the present invention is the dynamic viscosity at 20° C. if noting else is stated. In the context of the present invention the change in dynamic viscosity of an oil is expressed as Δ Pa·s/° C. Alternatively, the change in dynamic viscosity of an oil is described as the difference between the dynamic viscosity at 25° C. and 20° C. (Pa·s at 25° C.−Pa·s at 20° C.=Δ Pa·s).

### Room Temperature

The term “room temperature” or (also referred to as ambient temperature) is denoting the temperature within enclosed space at which humans are accustomed. The room temperature (RT) in the context of the present invention is defined by the range of 15° C. to 29° C.

### Solid Fat Index (SFI)

The term “Solid fat index” (SFI) is used herein (SFI) is a measure of the percentage of fat in crystalline (solid) phase to total fat (the remainder being in liquid phase) across a temperature gradient.

### Peroxide Value

The best test for autoxidation (oxidative rancidity) is determination of the “peroxide value”. Peroxides are intermediates in the autoxidation reaction. The number of peroxides present in edible fats and oils is an index of their primary oxidative level and consequently of its tendency to go rancid. The lower is the peroxide value, the better is fat or oil quality and its status of preservation. Other methods are available but peroxide value is the most widely used. The double bonds found in fats and oils play a role in autoxidation. Oils with a high degree of unsaturation are most susceptible to autoxidation. Autoxidation is a free radical reaction involving oxygen that leads to deterioration of fats and oils which form off-flavours and off-odours. Peroxide value, concentration of peroxide in an oil or fat, is useful for assessing the extent to which spoilage has advanced.

The peroxide value is defined as the amount of peroxide oxygen per 1 kilogram of fat or oil. Typically this is expressed in units of milliequivalents (mequiv or meq). If SI units are used the appropriate unit is millimoles per kilogram (1 millimole=2 milliequivalents).

The peroxide value of the oil also affects the preservation of the probiotic organism for which the oil is used as vehicle in the vacuum inclusion of the probiotic organism in an extruded food product. An oil with a low peroxide value is preferred as vehicle due to the better probiotic preservative properties over an oil with a higher peroxide value.

### Preservative

“Preservative” refers to a natural or synthetic substance that is added to the food product to preserve the product. “Probiotic preservative” refers to a substance that preserves the probiotic organism in the sense of the ability of the organism to establish and populate the gastro-intestinal system of the host (e.g. a human being or an animal such as a pet animal). The preservation is reflected in the colony-forming unit (CFU) of the final food product and/or the sustained CFU of the final food product over time of storage.

### Antioxidant

The term “antioxidant” refers to a substance capable of slowing or preventing the oxidation of other substances. Antioxidants are frequently used as food additives to reduce food deterioration. Both synthetic and natural antioxidants are used. Natural antioxidants have been identified among a wide range of classes of compounds such as flavanoids, cartonoids, tocotrienol, tocopherol and terpenes (such as astaxanthin). In one embodiment of the invention the synthetic antioxidant is selected from the group consisting of BHA and BHT and natural antioxidant is selected from the group consisting of Vitamin E flavonoids, and polyphenolics. The natural antioxidant may be provided in the form of an extract for example rosemary or grape seed extracts (comprising resveratrol).

### CFU

The term “colony-forming unit (CFU)” is a measure of the number viable bacterial or fungal organisms. Unlike in direct microscopic counts where all cells, dead and living, are counted, CFU measures viable cells. CFU is typically given in CFU per unit of the matter comprising the CFU. Thus, CFU is typically given in CFU/I or CFU/g of matter comprising the colony-forming unit. The CFU of a matter is typically assessed by suspending a known amount of the matter in a suitable liquid. The liquid may subsequently be subjected to further dilution, which is used for inoculation in a suitable growth media such as plates of clear nutrient agar or a suitable alternative. The number of colonies formed on a nutrient agar after e.g. 24 hour incubation may be used to calculate the CFU of the matter in question.

### Extrusion, Extruded

The terms “extrusion” or “extruded” refers in the present context to “cooking extrusion” which is a combination of heating of food products with the act of extrusion to create a cooked and shaped food product and is a process in which moistened, starchy, proteinaceous foods are cooked and worked into a viscous, plastic-like dough. The results of cooking the food ingredients during extrusion may be: 1) gelatinization of starch, 2) denaturation of protein, 3) inactivation of raw food enzymes, 4) destruction of naturally occurring toxic substances, and 5) diminishing of microbial counts originating from the pre-extruded product. Upon discharge through the die, the hot, plastic extrudate expands rapidly with loss of moisture and heat because of sudden decrease in pressure. After expansion cooling, and drying, the extruded product develops a rigid structure and maintains a porous texture. A further object of the extrusion is to eliminate any bacteria present in the ingredients.

### Density

The term “density” of a material is defined as the mass of the material per unit volume (g/L).

Food Product

The term “food product” as used herein refers to any food product to which the beneficial function of probiotics is wished to be added. For example, it may be a breakfast cereals, pet food, treats. However, it may be any food, intended for any humans and/or animals. For example, the food product may be a particulate food or food ingredient, such as extruded snack products, tortilla chips, breakfast cereal , cookies, crisp bread, food foams, Rice brokens, blend of peanut, soybean and corn, puffed wheat, low density foamed corn and rice breakfast, Co-extruded products, muesli bars and any other extruded products that are formed by extrusion process. “Pet food” in the context of the present invention refers to food products obtained by methods of extrusion. For example, a food kibble such as a dog food kibble.

### Pet

The term “pet” refers to an animal kept for companionship and enjoyment or a household animal, as opposed to livestock, laboratory animals, or working animals, which are kept for economic reasons. Accordingly, pet food is a food product intended for consumption by a pet (such as a dog food or a cat food).

### Probiotic

The term “probiotic” or “probiotic micro-organism” as used herein is defined as a live microbial feed supplement which beneficially affects the host animal by improving its intestinal microbial balance. The probiotic micro-organism may be in an ametabolic state of life such a cryptobiosis (e.g. anhydrobiosis) as a consequence of cryopreservation (such as freeze-drying). However, the probiotic micro-organism will revert into a metabolic state of life when exposed to an environment enabling the metabolic state of life. Accordingly, a dead organism such as a dead micro-organism does not fall within the definition of a probiotic organism due to the fact that it is not capable of populating and the improving the intestinal microbial balance of the host in question.

A probiotic bacteria refers to a bacteria with probiotic properties. No limiting examples of suitable probiotic micro-organisms include yeasts such as Saccharomyces, Debaromyces, Candidaw Pichia and Torulopsis, moulds such as Aspergillus, Rhizopus, Mucor, and Penicillium and Torulopsis and bacteria such as the genera Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus. Specific examples of suitable probiotic micro-organisms are: Aspergillus niger, A. oryzae, Bacillus coagulans, B. lentus, B. licheniformis, B. mesentericus, B. pumilus, B. subtilis, B. natto, Bacteroides amylophilus, Bac. capillosus, Bac. ruminocola, Bac. suis, Bifidobacterium adolescentis, B. animalis, B. breve, B. bifidum, B. infantis, B. lactis, B. longum, B. pseudolongum, B. thermophilum, Candida pintolepesii, Clostridium butyricum, Enterococcus cremoris, E. diacetylactis, E. faecium, E. intermedius, E. lactis, E. muntdi, E. thermophilus, Escherichic coli, Kluyveromyces fragilis, Lactobacillus acidophilus, L. alimentarius, L. amylovorus, L. crispatus, L. brevis, L. casei L. curvatus, L. cellobiosus, L. delbrueckii ss. bulgaricus, L farciminis, L. fermentum, L. gasseri, L. helveticus, L. lactis, L. plantarum, L. johnsonii, L. reuteri, L. rhamnosus, L. sakei, L. salivarius, Leuconostoc mesenteroides, P. cereviseae (damnosus), Pediococcus acidilactici, P pentosaceus, Propionibacterium freuclenreichii, Prop. shertnanii, Saccharontyces cereviseae, Staphylococcus carnosus, Staph. xylosus, Streptococcus infantarius, Strep. Salivarius ss. thermophilus, Strep. thermophilus, Strep. lactis.

### Stability of the Product

As used herein, the term “shelf life” refers to that property of the products of the invention whereby about 1% or more, alternatively about 5% or more, alternatively about 10% or more, alternatively about 25% or more, alternatively about 50% or more, alternatively about 75% or more, of the probiotic micro-organisms are viable (see also definitions of CFU) at the referenced time period after exposure to ambient environmental conditions. The shelf life of the products of the invention is 6-36 month, such as 6-24 month, such as 9-20 month, and such as 12-16 month.

### Shelf-Life

The probiotic comprising products of the invention may have a superior shelf-life. Thus, in an embodiment of the invention the count of at least one probiotic in the food product is 10⁴-10¹⁶ CFU/kg, such as 10⁵-10¹⁶, such as 10⁶-10¹⁶, such as 10⁷-10¹⁶, such as 10⁷-10¹⁴, such as 10⁷-10¹², such as 10⁷-10¹⁰, or such as 10⁸-10¹⁰ CFU/kg after at least 3 month after the date of manufacturing.

In another embodiment of the invention the count of at least one probiotic in the food product is 10⁴-10¹⁶ CFU/kg, such as 10⁵-10¹⁶, such as 10⁶-10¹⁶, such as 10⁷-10¹⁶, such as 10⁷-10¹⁴, such as 10⁷-10¹², such as 10⁷-10¹⁰, or such as 10⁸-10¹⁰ CFU/kg after at least 6 month after the date of manufacturing.

In a further embodiment of the invention the count of at least one probiotic in the food product is 10⁴-10¹⁶ CFU/kg, such as 10⁵-10¹⁶, such as 10⁶-10¹⁶, such as 10⁷-10¹⁶, such as 10⁷-10¹⁴, such as 10⁷-10¹², such as 10⁷-10¹⁰, or such as 10⁸-10¹⁰ CFU/kg after at least 10 month after the date of manufacturing.

In yet a further embodiment of the invention the count of at least one probiotic in the food product is 10⁴-10¹⁶ CFU/kg, such as 10⁵-10¹⁶, such as 10⁶-10¹⁶, such as 10⁷-10¹⁶, such as 10⁷-10¹⁴, such as 10⁷-10¹², such as 10⁷-10¹⁰, or such as 10⁸-10¹⁰ CFU/kg after at least 15 month after the date of manufacturing.

In an additional embodiment of the invention the count of at least one probiotic in the food product is 10⁴-10¹⁶ CFU/kg, such as 10⁵-10¹⁶, such as 10⁶-10¹⁶, such as 10⁷-10¹⁶, such as 10⁷-10¹⁴, such as 10⁷-10¹², such as 10⁷-10¹⁰, or such as 10⁸-10¹⁰ CFU/kg after at least 20 month after the date of manufacturing.

It is to be understood that these counts may achieved following standard storing conditions (shelf-life) known to the person skilled in the art.

### Vacuum Infusion

The terms “vacuum infusion” refers to inclusion of a substance and dispersion of the substance throughout the body of an object by means of vacuum. For example, vacuum infusion may be infusion of a suspension (comprising a vehicle and at least one probiotic micro-organism) in a of porous food matrices such as a pet food kibble by means of a vacuum infusion process, vacuum infusion of a fat, and vacuum infusion of a digest in e.g. a pet food product such as a pet food kibble.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### Suspension of Probiotic Micro-Organism and Vehicle Oil

One aspect of the present invention relates a suspension for vacuum infusion of an extruded probiotic food product, wherein said suspension comprises an oil and at least one probiotic micro-organism in the concentration of 10⁶-10¹⁶ CFU/kg of said oil and said suspension having a dynamic viscosity of less than 0.08 pascal-second (Pa·s)at 20° C. The suspension is for use in the preparation of an extruded food product and serves as a mean of obtaining a probiotic food extruded product characterized by homogenously distribution of the probiotic micro-organisms throughout the porous matrices of the food product. In order accomplish this object, the substances for the preparation of the suspension should be carefully selected. The suspension in the final form ready for use in the manufacturing of the probiotic food extruded product should enable an efficient vacuum infusion process without interfering with the manufacturing process such as clotting various parts of the apparatus used in the manufacturing. For example, the inventors have experienced that the use of probiotic/oil suspension may clot the fluidic system e.g. by clotting the nozzle used for spraying the suspension on the product in a vacuum coater/vacuum infusion tank. The accumulation of matter from the suspension in the system leading to clotting of the fluidics such clotting of the spraying nozzle may result in premature termination of the production in order to clean and eventually repair the line of production. One key parameter is the viscosity of the probiotic oil suspension for the vacuum infusion process. In their effort to avoid the very unfortunate terminations of the production of the manufacturing of the probiotic food extruded product, the inventors discovered the importance of the viscosity of the oil used as vehicle in the suspension. Further, the inventors discovered that although the oil may be suitable as such for vacuum infusion, the physical properties of the probiotic/oil suspension based on the oil may be different and the suspension may not be suitable for the vacuum infusion process due to a suboptimal viscosity.

The probiotic/oil suspension of the invention comprises at least one oil and at least one probiotic micro-organism. In one embodiment, the suspension comprises additionally at least one additive. The present invention provides a suspension comprising at least one oil and at least one probiotic micro-organism for application in a vacuum having a dynamic viscosity of less than 0.08 pascal-second (Pa·s) at 20° C.

### Properties of Oil Used in the Suspension

### Dynamic Viscosity of the Vehicle Oil

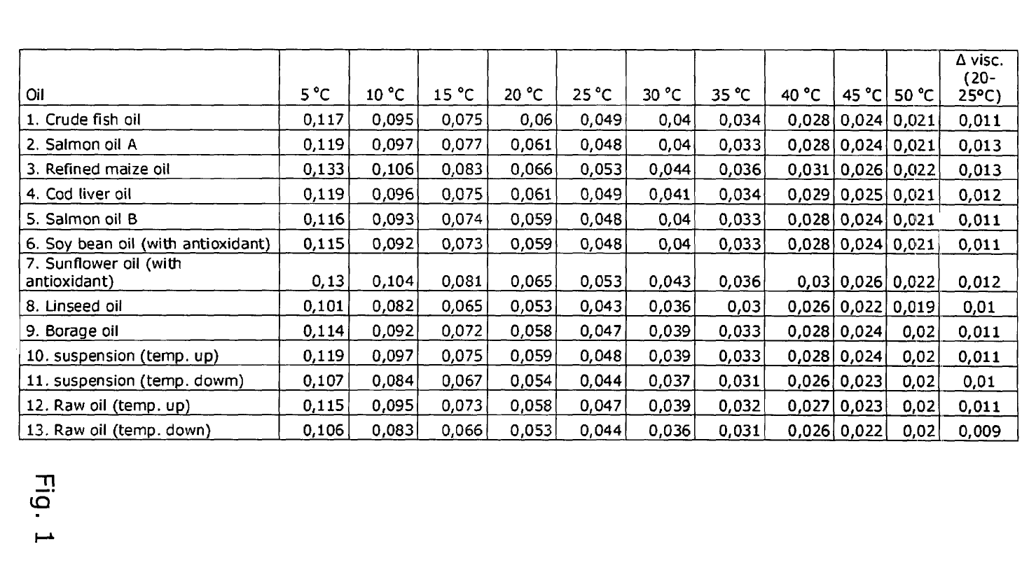

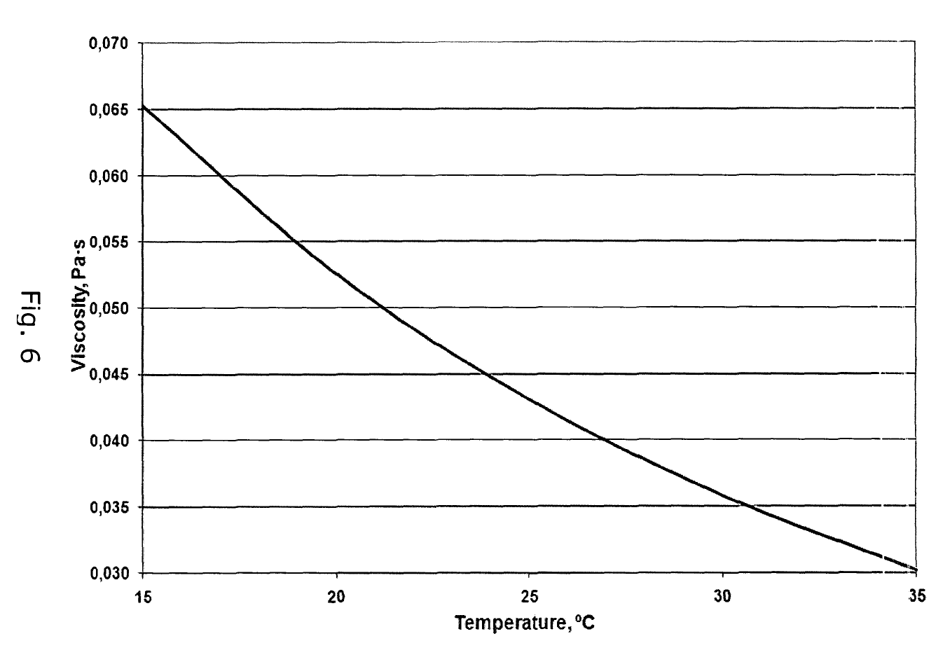

The oil component of the suspension serves the purpose of a vehicle. In one embodiment of the invention, the oil of the suspension has a dynamic viscosity of less than 0.08 pascal-second (Pa·s)at 20° C., such as less than 0.075 pascal-second (Pa·s) at 20° C., for example less than 0.070 pascal-second (Pa·s) at 20° C., such as less than 0.065 pascal-second (Pa·s) at 20° C., for example less than 0.060 pascal-second (Pa·s)at 20° C., such as less than 0.055 pascal-second (Pa·s) at 20° C., for example less than 0.050 pascal-second (Pa·s)at 20° C., such as less than 0.045 pascal-second (Pa·s) at 20° C., for example less than 0.040 pascal-second (Pa·s) at 20° C. In one embodiment, the dynamic viscosity of the vehicle oil is less than 0.060 pascal-second (Pa·s) at 20° C. An example of an oil having a viscosity at 20° C. of less than 0.060 pascal-second (Pa·s) is linseed oil (Vobra Special Petfoods BV, Netherlands) (see FIGS. 1, 4 and 6). In a further, embodiment, the dynamic viscosity of the vehicle oil within the range of 0.050 to 0.07 pascal-second (Pa·s) at 20° C., such as the range of 0.053 to 0.066 pascal-second (Pa·s) at 20° C.

Thus, in an alternative aspect the invention relates to a suspension for vacuum infusion of an extruded probiotic food product, wherein said suspension comprises an oil and at least one probiotic micro-organism in the concentration of 10⁶-10¹⁶ CFU/kg of said oil, and wherein said oil having a dynamic viscosity of less than 0.08 pascal-second (Pa·s) at 20° C. This particular aspect specifies the viscosity to the oil and not the suspension. It is to be understood that the embodiment relating to the other aspects of the invention also relate to this particular aspect.

Δ Pa·s of the oil vehicle between 20° C. and 25° C.

The change in viscosity of the oil vehicle between 20° C. and 25° C. may be an important feature of the oil vehicle. Thus, in an embodiment according to the invention the Δ Pa·s between 20° C. and 25° C. of the oil vehicle is at least 0.009, such as such as in the range 0.009-0.05 Pa·s, such as in the range 0.01-0.05 Pa·s, such as 0.01-0.04 Pa·s, such as 0.013-0.020 Pa·s, such as in the range 0.013-0.018 Pa·s such as in the range 0.013-0.016 Pa·s. An example of an oil in these intervals is salmon oil A (see FIGS. 1, 2 and 4).

In the present context delta viscosity (Δ Pa·s) is calculated by subtracting the viscosity at 20° C. from the viscosity at 25° C. Viscosity of oils is calculated using the method disclosed in example 1.

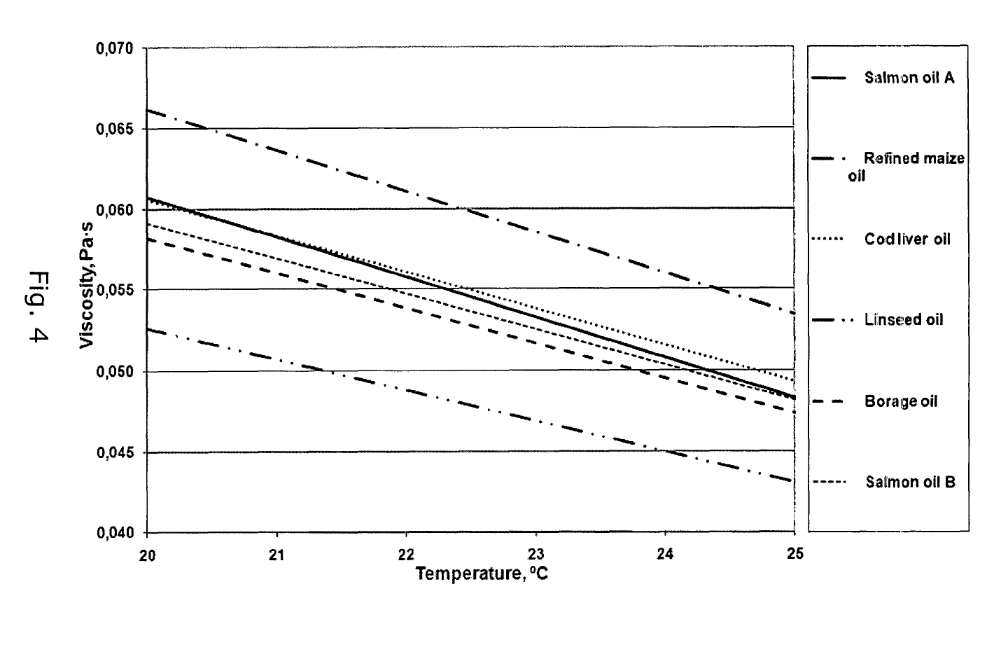

In an additional embodiment the oil vehicle has either a dynamic viscosity of less than 0.08 Pa·s or a Δ Pa·s of the oil vehicle between 25° C. and 20° C. of at least 0.009 Pa·s. Examples of such oils are salmon oil A and linseed oil (see FIGS. 1 and 4).

In yet an embodiment the oil vehicle has a dynamic viscosity of less than 0.08 Pa·s and a Δ Pa·s of the oil vehicle between 25° C. and 20° C. in the range 0.009-0.05 Pa·s. An example of such an oil is salmon oil A (see FIGS. 1 and 4).

It is to be understood that the intervals provided for the dynamic viscosity and the delta viscosity of the oil vehicles according to the invention also apply to the embodiments relating to the combination of the two embodiments and the embodiments which relate to an alternatives between the two embodiments.

### Classes of Oils

The oil may be any to any edible vegetable and animal oils or a combination of at least one edible vegetable and one edible animal oils. Accordingly, in one embodiment the oil is selected from the group consisting of vegetables oil and animal oil or a combination thereof. Animal oils include fish oil. In a further embodiment, the oil is selected the group consisting of vegetables oil and fish oil. In embodiment of the present invention the oil is a fish oil. The fish oils in the context of the present invention include but are not limited to salmon oil, mackerel oil, lake trout oil, herring oil, sardine oil, albacore tuna oil, cod liver oil, sand eel oil (Ammodytes tobianus), and menhaden oil. In one embodiment, is selected from the group consisting of salmon oil, mackerel oil, lake trout oil, herring oil, sardine oil, albacore tuna oil, cod liver oil, sand eel oil (Ammodytes tobianus), and menhaden oil. In a further embodiment, the fish oil is salmon oil. The oil may be refined oil, a crude oil or a mixture of oils. Thus, in one embodiment the oil is crude fish oil.

The source of the oil may also be suitable vegetable oils. Thus in one embodiment, the oil is a vegetable oil, such as oil of flax or flax seed (commonly known as linseed). In another embodiment, the oil is selected from linseed oil, olive oil, borage oil, lin oil, camelina oil, grape seed oil, chia oil, kiwifruit seeds oil, perilla oil, lingonberry, purslane oil, seabuckthorn oil, hemp oil, refined maize oil, soy bean oil, sunflower oil. In a further embodiment, the oil is linseed oil. Linseed oil has unique viscosity properties as described in the present application, which may make it a unique oil vehicle.

### Saturated Versus Unsaturated Fatty Acids

Oil such as vegetable oils and fish oil are compositions comprising saturated and unsaturated fatty acids. The group of unsaturated fatty acids includes mono-unsaturated fatty acids as well as poly-unsaturated fatty acids. The ratio of saturated to unsaturated fatty acids varies among oils. For dietary application oils rich in unsaturated fatty acids are highly preferred due to the health benefits of the unsaturated fatty acids over the saturated fatty acids. Thus, the oil used in the suspension is preferably rich in unsaturated fatty acids. Thus, in one embodiment, the oil is rich in unsaturated fatty acids such as mono-unsaturated and/or poly-unsaturated fatty acids. Thus in one embodiment the ratio of saturated to unsaturated fatty acids varies the oil is less 5 to 1, such as less than 4 to 1, such as less than 3 to 1, such as less than 2 to 1, such as less than 1 to 1. The content of unsaturated fatty acids in the oil may be higher than the content of saturated fatty such that the ratio of unsaturated to saturated fatty acids is 2 to 1 or more, such as 3 to 1 or more, such as 4 to 1 or more, such as 5 to 1 or more, such as 6 to 1 or more, such as 7 to 1 or more, such as 8 to 1 or more, such as 9 to 1 or more, such as 10 to 1 or more.

The ratio of saturated to unsaturated fatty acids varies among oils. For example, flaxseed oil comprises 9% of saturated fatty acids, 18% mono-unsaturated fatty acids, and 73% of polyunsaturated fatty acids. In contrast, coconut oil comprise 91% saturated fatty acids, 7% mono-unsaturated fatty acids, and 2% poly-unsaturated fatty acids.

In order to sustain the key health benefits and features of the food product, the product described in this invention may comprise a high level of unsaturated fatty acids. MSS to JAL: Since food also includes pet food, does this always rules? Furthermore, the total amount of fats in the food product may range 0.5% till 45% of net weight of the product, where preferably the ratio between saturated to unsaturated fats within the total fat content shall range 1/1-20/1.

Known health beneficial unsaturated fatty acids are omega-3 (n-3) fatty acids such as α-linolenic acid (ALA), eicosapentaenoic acid (EPA), and docosahexaenoic acid (DHA) and omega-6 (n-6) fatty acids such as linoleic acid and arachidonic acid.

Accordingly, in one embodiments of the invention the oil of the suspension comprises the unsaturated fatty acid selected from the group consisting of α-linolenic acid (ALA), eicosapentaenoic acid (EPA), and docosahexaenoic acid (DHA) and omega-6 fatty acids such as linoleic acid and arachidonic acid. In one embodiment the oil of the suspension is rich the unsaturated fatty acids, wherein the unsaturated fatty acids are n-3 fatty acids. In general it is to be understood that the group of unsaturated fatty acids includes mono-unsaturated fatty acids and poly-unsaturated fatty acids.

Thus in yet an embodiment the unsaturated fatty acids of the oil of the suspension comprises at least one of α-linolenic acid (ALA), eicosapentaenoic acid (EPA), docosahexaenoic acid (DHA), linoleic acid and arachidonic acid.

### Perioxide Level of Vehicle Oil

Another important parameter of the vehicle oil of the suspension is the peroxide level of the oil. Peroxides are intermediates in the autoxidation reaction and the peroxide level of the oil reflects the degree of rancidification oil and thus the quality of the oil. Apart from deterioration of fats and oils which form off-flavours and off-odour due to rancidification, a high level of peroxide also affects the preservation of the probiotic organism for which the oil is used as vehicle in the vacuum inclusion of the probiotic organism in an extruded food product. An oil with a low peroxide value is preferred as vehicle due to the better probiotic preservative properties over an oil with a higher peroxide value.

Accordingly, in one embodiment of the present invention the wherein the peroxide level of said oil is less that 6 meq O₂/kg oil, such as less than 5 meq O₂/kg, such as less than 4 meq O₂/kg, such as less than 3 meq O₂/kg. In a preferred embodiment of the present invention the peroxide level of the oil is less that 2 meq O₂/kg. In another embodiment, the peroxide level of said oil is not more than 2 meq O₂/kg such as 2 meq O₂/kg.

### Additive

The suspension of the invention may comprise at least one additive. Thus in one embodiment of the invention the suspension for vacuum infusion of an extruded food product comprises an additive such as an antioxidant. The additive may serve at least the function of preserving the oil vehicle component for example by reducing the accumulation of peroxide in the oil. By minimizing the accumulation of peroxide in the oil the quality of the oil is maintained during storage of the probiotic extruded food product. Oils with a high degree of unsaturation are most susceptible to autoxidation. The peroxide value of the oil also affects the preservation of the probiotic organism for which the oil is used as vehicle in the vacuum inclusion of the probiotic organism in an extruded food product. Accordingly, adding an antioxidant to the suspension reduce autoxidation reaction of the thereby maintaining the quality oil the oil in terms of food quality but also in terms of preserving the probiotic comprised in the probiotic food product and a fixed level of the unsaturated fats.

Thus, in one embodiment of the invention the suspension comprises at least one additive. In a further embodiment, the suspension comprises an antioxidant. In yet another embodiment, the antioxidant is selected from the group consisting of natural antioxidants and synthetic antioxidants. In one embodiment of the invention the synthetic antioxidant is selected from the group consisting of BHA and BHT and natural antioxidant is selected from the group consisting of Vitamin E flavonoids, and polyphenolics. The natural antioxidant may be provided in the form of an extract for example rosemary or grape seed extracts (comprising resveratrol).

Preferably, natural antioxidants are used. Accordingly, in yet another embodiment the antioxidant is natural antioxidant selected from the group consisting of flavanoids, cartonoids, tocotrienol, tocopherol and terpenes. In a particular embodiment, the antioxidant is astaxanthin.

### Probiotic Micro-Organism of the Suspension

The probiotic micro-organism(s) (probiotic(s)) are added to the extruded food product as supplement in order to improving the intestinal microbial balance the host animal (such as human being or pet). The probiotic micro-organism used by the present invention is preferably in preserved state such as freeze-dried. The size of the freeze-dried particles are from 1 μm and larger. In the freeze-dried form the probiotic micro-organism is a metabolic state of life as a consequence of cryopreservation. However, the probiotic micro-organism will revert into a metabolic state of life when exposed to an environment enabling the metabolic state of life and populate the environment such as the intestinal of the host. Accordingly, a non-viable (dead) micro-organism is not a probiotic micro-organism.

The state of preservation is further sustained by the use of the oil in the suspension of the invention. Thus, apart from serving the purpose of vehicle for infusion of the probiotics into the extruded food product, the oil also function as a preservation of the probiotic micro-organism embedded in the food product. Thereby, the stability of the probiotic food product is improved and the shelf life of the final food product increased.

Probiotics are diverse and identified both among bacteria and fungi. Probiotic micro-organism from both kingdoms are suitable in the context of the present invention.

In one embodiment, the suspension of the invention comprises at least one probiotic micro-organism is selected from the group consisting of bacteria, yeast and mold. In another embodiment of the invention, the at least one probiotic micro-organism is bacteria selected from the group consisting of Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus.

In further embodiment, the at least one probiotic micro-organism is bacteria selected from the group consisting of Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus.

In yet another embodiment of the invention, the at least one probiotic is a yeast selected from the group consisting of Saccharomyces, Debaromyces, Candidaw Pichia and Torulopsis. In one embodiment of the invention, the at least one probiotic is a mold selected from the group consisting of Aspergillus, Rhizopus, Mucor, and Penicillium and Torulopsis.

In yet an embodiment of the invention, the probiotic micro-organism is selected from the group consisting of Aspergillus niger, A. oryzae, Bacillus coagulans, B. lentus, B. licheniformis, B. mesentericus, B. pumilus, B. subtilis, B. natto, Bacteroides amylophilus, Bac. capillosus, Bac. ruminocola, Bac. suis, Bifidobacterium adolescentis, B. animalis, B. breve, B. bifidum, B. infantis, B. lactis, B. longum, B. pseudolongum, B. thermophilum, Candida pintolepesii, Clostridium butyricum, Enterococcus cremoris, E. diacetylactis, E. faecium, E. intermedius, E. lactis, E. muntdi, E. thermophilus, Escherichic coli, Kluyveromyces fragilis, Lactobacillus acidophilus, L. alimentarius, L. amylovorus, L. crispatus, L. brevis, L. casei L. curvatus, L. cellobiosus, L. delbrueckii ss. bulgaricus, L farciminis, L. fermentum, L. gasseri, L. helveticus, L. lactis, L. plantarum, L. johnsonii, L. reuteri, L. rhamnosus, L. sakei, L. salivarius, Leuconostoc mesenteroides, P. cereviseae (damnosus), Pediococcus acidilactici, P pentosaceus, Propionibacterium freuclenreichii, Prop. shertnanii, Saccharontyces cereviseae, Staphylococcus carnosus, Staph. xylosus, Streptococcus infantarius, Strep. Salivarius ss. thermophilus, Strep. thermophilus, Strep. lactis.

The choice of probiotic organism depends on the specific application in question e.g. pet food such as dog food. Enterococcus faecium is suitable for probiotic dog food. Thus, in a preferred embodiment the at least one probiotic micro-organism is Enterococcus faecium. The suspension may subsequently be used for the preparation of a probiotic extruded food product for dogs (e.g. a probiotic dog food kibble comprising Enterococcus faecium). In a particular embodiment, the at least one probiotic micro-organism is the NCIMB 10415 strain of Enterococcus faecium. The NCIMB 10415 strain may be EC No. 13 (E1707 (new classification)).

In one embodiment, the probiotic micro-organism is applied to the suspension in a dry powder form, wherein the concentration of the probiotic micro-organism in the dry powder is in the range of 10⁹-10¹⁷ CFU/kg dry powder, such as 10⁹-10¹⁶, such as 10¹⁰-10¹⁶, such as 10¹⁰-10¹⁵ CFU/kg dry powder, such as 10¹⁰-10¹⁴ CFU/kg dry powder.

### Properties of the Suspension of the Invention

The probiotic/oil suspension of the invention comprises at least one oil and at least one probiotic micro-organism. The probiotic/oil suspension for application in a vacuum has a dynamic viscosity of less than 0.08 pascal-second (Pa·s) at 20° C.

The component of the suspension comprising the oil and the at least one probiotic micro-organism is selected and balanced in the suspension to accomplish that the suspension is applicable for the vacuum infusion process. Accordingly, the component of the suspension is balanced to accomplish a dynamic viscosity of the suspension less than 0.08 pascal-second (Pa·s) at 20° C.

Accordingly, in one embodiment of the invention, the dynamic viscosity of the suspension is less than 0.08 pascal-second (Pa·s)at 20° C. In another embodiment of the invention, the dynamic viscosity of the suspension is less than 0.06 pascal-second (Pa·s)at 20° C. In a further embodiment, the dynamic viscosity of the suspension is in the range of 0.04 to 0.06 pascal-second (Pa·s)at 20° C.

Preparing the suspension to obtaining a suspension with the dynamic viscosity within the above ranges ensures that accumulation of matter from the suspension in the system is minimized. Clotting of the fluidics such clotting of the spraying nozzle is prevented, which reduce the frequent premature terminations of the production in order to clean and eventually repair the line of production.

In one embodiment of the invention, the concentration of the at least one probiotic micro-organism is 10⁶-10¹⁶ CFU/kg of the oil component of the suspension such as 10⁷-10¹⁶ CFU/kg, such as 10⁷-10¹⁶ CFU/kg, such as 10⁸-10¹⁶ CFU/kg, such as 10⁹-10¹⁶ CFU/kg, such as 10⁹-10¹⁴ CFU/kg, such as 10⁹-10¹⁴ CFU/kg, or such as 10¹⁰-10¹⁴ CFU/kg. In a further embodiment, the concentration of the probiotic micro-organism takes into account that the probiotic extruded food product obtained using the suspension should have 1×10⁹ till 3.5×10¹⁰ CFU/kg of complete food, and that the suspension is suitable for vacuum infusion in the view of the above such as a dog food enriched by E. faecium.

### Preparation of a Suspension of Probiotic Micro-Organism and Vehicle Oil

One aspect of the present invention relates to a method of preparing a suspension of the invention, said method comprising:
a) providing at least one probiotic micro-organism in a dry powder form having a total concentration of 10⁹-10¹⁷ CFU/kg dry powder
b) providing an oil
c) adding 0.3 to 15 kg of said probiotic micro-organism powder per 100 kg oil to said oil in an container at continuously stirring at RT to make a suspension premix
d) transferring the suspension premix of c) to a storage tank comprising mixing means with the proviso that the transfer is not by vacuum suction
e) mixing said premix suspension RT to obtain a suspension of homogenously dispersed probiotic micro-organism
   and obtaining said suspension.

The container employed in the method may be an IBC-container or other suitable container. The container has preferably a bottom outlet for the emptying the premix. The oil employed in the method is a suitable oil in context of the invention as described above.

Bacteria powder is added gradually to the oil at continuously mixing (such as rotation speed of 5-350 RPM) at room temperature.

In one embodiment, the total concentration of the at least one probiotic micro-organism in said dry powder form is in the range of 10¹⁰ to 10¹³ CFU/kg dry powder, such as 10¹¹ to 10¹³ CFU/kg dry powder, such as 10¹² to 10¹³ CFU/kg dry powder, such as 10¹³ CFU/kg dry powder. In a further embodiment, 3.3 to 6.7 kg of said probiotic micro-organism powder per 100 kg is added to said oil in the container. In yet another embodiment, the premix is mixed for no more than 3 hours of mixing. In yet another embodiment, the premix is mixed for no more than 1 hour of mixing. In an additional embodiment the premix is mixed for not less than 1 hour. In yet an embodiment the premix is mixed for not less than 1 hours and not more than 3 hours.

### Use of the Suspension of the Invention for Manufacturing a Probiotic Food Product.

The concentration of the probiotic ingredient in the final probiotic food product obtained by using the suspension of the invention should be in range regulated by EU registration 1×10⁹ to 3.5×10¹⁰ CFU/kg of complete food stuff (EC nr E1707) accordingly to Official Journal of the European Union, COMMISSION REGULATION (EC) No 1520/2007 of 19 Dec. 2007.

Accordingly, the suspension is applied to the food product by vacuum infusion taken into account at least the concentration of the probiotic micro-organism in the suspension, loss of probiotic in the line of manufacturing and calibrated accordingly to accomplish a CFU within the range 10⁵ to 10¹⁵ CFU/kg of complete food stuff such as in the range of 1×10⁹ to 3.5×10¹⁰ CFU/kg of complete food stuff.

One aspect of the present invention concerns the use of a suspension of the present invention for the preparation of a extruded probiotic food product, wherein said suspension comprises an oil and at least one probiotic micro-organism in the concentration of 10⁶-10¹⁶ CFU/kg of said oil and said suspension having a dynamic viscosity of less than 0.08 pascal-second (Pa·s)at 20° C.

Another aspect of the present invention relates to a method of producing an extruded food product comprising at least one probiotic micro-organism, wherein said probiotic micro-organism is homogenously distributed throughout the structure of the food product by vacuum inclusion of the suspension of the present invention.

In one embodiment, the food product is a pet food product. In another embodiment, the food product is a human food product.

### Extruded Probiotic Food Product

A final aspect of the present invention concerns, an extruded probiotic food product obtained by a method and/or the methods described above.

In one embodiment, the minimal amount of the probiotic in the product is in the range of 10⁵ CFU/Kg to 10¹⁵ CFU/Kg, such as lx 10⁹ CFU/Kg to 7.5×10¹¹, such as 2.5×10⁹ CFU/Kg to 7.5×10¹¹. In another embodiment, the product % moisture is above 7%, preferably 8-10%.

### Plant Variations

To be able to produce a food product comprising probiotics a production plant is necessary. Thus in a first aspect the invention relates to a production plant for vacuum infusing a food product comprising
a first storage tank for storing a probiotic suspension, connected to a first dosage tank for dosing a probiotic suspension,
   wherein the first dosage tank is connected to a vacuum infusion tank by one or more spraying nozzles leading into the vacuum infusion tank.

In this way the probiotic suspension may be sprayed onto the food product positioned in the vacuum infusion tank.

It may be advantageous to be able to vacuum infuse more than two suspension/solution without having to change the content of the first or second storage tank and the first and second dosage tank. Thus, in a second aspect the invention relates to a production plant for vacuum infusing a food product comprising at least
a first storage tank for storing a probiotic suspension, said first storage tank being connected to a first dosage tank (7) for dosing a probiotic suspension,
a second storage tank for storing a fat solution, said second storage tank being connected to a second dosage tank for dosing a fat solution,
a third storage tank for storing a digest solution, said third storage tank being connected to a second or third dosage tank for dosing a digest solution, and
   wherein the first dosage tank, the second dosage tank and the third dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

In the production plant of the disclosed invention the probiotic suspension is kept separate from the other components which are going to be vacuum infused into the product. This is done having the first dosage tank individually connected to the vacuum infusion tank. An advantage is that optimal viability of the probiotics is maintained when the probiotic oil/fat suspension is kept distinct from the other solutions.

The solutions in the second dosage tank and the third dosage tanks may be connected to the vacuum infusion tank through a joined connection, which may make the plant simpler to construct.

Other solutions may be vacuum infused into the product of the invention. Thus, in a another embodiment the production plant further comprises at least a fourth storage tank for storing a solution, said fourth storage tank being connected to a fourth dosage tank for dosing a solution through one or more spraying nozzles.

The fourth storage tank and the fourth dosage tank may be optimized for storing additional solutions. The solutions in the second dosage tank, the third dosage tank and the fourth dosage tank may be connected to the vacuum infusion tank through a joined connection, which may make the plant simpler to construct.

It may also be advantageously to avoid intermixing of some of the solutions present in the dosage tanks. Thus, in another embodiment the invention relates to a production plant, wherein at least one of the following dosage tanks also is individually connected to the vacuum infusion tank by one or more spraying nozzles: the second dosage tank, the third dosage tank and the fourth dosage tank.

This may be advantageously, since intermixing of two or more of the different solutions may result in precipitation and clotting of the spraying nozzles.

### Intermixed Dosage Tanks

In some cases none of the solutions in the dosage tanks should be intermixed before they enter the vacuum infusion tank. Therefore, in yet another embodiment the invention relates to a production plant, wherein each of the following dosage tanks also is individually connected to the vacuum infusion tank by one or more spraying nozzles: the second dosage tank, the third dosage tank and the fourth dosage tank. This may be advantageously, since intermixing of two or more of the different solutions may result in precipitation and clotting of the spraying nozzles. Another advantage may be that e.g. the fourth storage tank and the fourth dosage tank can be saved as an extra infusion line in the case that e.g. the nozzles in one of the dosage tanks clots. In this way a fast switch can be made to the fourth infusion line and thus save expensive “down-time” where the plant may be out of order. It is to be understood that “infusion line” refers to the combination of vessels leading to the vacuum infusion tank, e.g. the fourth storage tank leading to the fourth dosage tank leading to the vacuum infusion tank through one or more spraying nozzles.

### Spraying Nozzles Orifice

Since different solutions are being sprayed onto the food products optimal spraying is required. Thus, in a further embodiment the invention relates to a production plant according to any of claims 1-4, wherein the orifice of each of the spraying nozzles has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm². The importance of having optimal nozzles for each type of solution is that the efficiency of the spraying depend on the orifice of each of the spraying nozzles and the viscosity of the solution passing through the nozzle. Furthermore, spraying also depend on the speed the solution is passed through the nozzle. Thus, it is to be understood that each infusion line do not necessary have the same type of spraying nozzles.

### Cross-Sectional Area

Therefore, in an additional embodiment the orifice of each of the spraying nozzles connected to the first dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm², and the orifice of each of the spraying nozzles connected to the second dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm², and the orifice of each of the spraying nozzles connected to the third dosage tank has a cross-sectional area of 1-250 mm², possibly 1-200 mm², such as 1-150 mm², or 1-100 mm², or 1-50 mm², or 1-25 mm², or 1-15 mm2 or 1-10 mm2 or 1-5 mm2 or 1-3 mm2, and the orifice of each of the spraying nozzles connected to the fourth dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm².

### Bottom Outlet

To be able to maintain a high viability of the probiotics during the whole process of vacuum infusion, correct handling of the solution is required. Thus, in yet a further embodiment the invention relates to a production plant, wherein a first mixing tank is connected to the first storage tank through a bottom outlet in the first mixing tank, and where the probiotic suspension is intended for being passed from the first mixing tank to the first storage tank at least by means of gravity, possibly by means of gravity only. An advantage of having an additional mixing tank is that mixing freeze- dried probiotics into the oil/fat suspension may result in flakes/precipitates of micro-organisms if the micro-organisms are added too fast to the suspension. Furthermore, manually mixing may be advantageously. An example of a mixing tank is an IBC tank. When the suspension is transferred to the first storage tank it is also important not to supply too much force to the suspension since it may result in loss of viability of the probiotics. By having an outlet positioned at the bottom of the mixing tank and the first storage tank positioned below the mixing tank, the suspension can be transferred to the storage tank only by the force of gravity. Alternatively, the outlet may be positioned otherwise such as on side of the mixing tank 1. The mixing tank may be adapted to allow emptying the tank from e.g. an outlet positioned on side of the mixing tank.

### Vacuum Suction Unit Proviso

Thus, in an embodiment the connection between the first mixing tank and the first storage tank does not comprise a vacuum suction unit. In another embodiment the connection between the first mixing tank and the first storage tank does not comprise a positive displacement unit. Both a vacuum suction unit and a positive displacement unit may be harmful to the viability of the probiotics. Furthermore by minimizing the surfaces the probiotics come in contact with, loss of probiotics due to sticking to the surfaces of e.g. long tubes, loss of viability may also be avoided.

### Mixing Means

It is important that the probiotics stay/become evenly distributed in the suspension when the suspension is maintained in the first storage tank. Thus, in a further embodiment the first storage tank comprises at least one of the following means for mixing: a rotating impeller, a rotating mixing tank, or a combination of an impeller and a rotating tank. By having the first storage tank comprising means for mixing, such as an impeller, a rotating tank or a combination of both, sedimentation of the probiotics may be avoided. The person skilled in the art would know of other means for mixing which may be suitable for the described purpose.

Opening for Applying Uncoated Food

The vacuum infusion tank also has to be able to receive the food product (not yet infused) before the vacuum infusion begins. Thus, in yet an embodiment the vacuum infusion tank comprises at least one opening for applying the uncoated food product to said vacuum infusion tank. The food product (before infusion) may be transferred to the vacuum infusion tank directly from a drying device, which means that the un-infused food product may have a temperature above ambient temperature when it enters the vacuum infusion tank. Thus, in an embodiment the vacuum infusion tank is connected to a drying device. A higher amount of solutions/suspensions are being infused into the product when the product has a temperature of 20-50° C., such as 20-45° C., 25-50° C., 30-45° C., without resulting in significant loss of viability of the probiotics.

### Pressure

The vacuum infusion tank may be constructed to decrease the pressure inside the tank to a vacuum. Thus, in an embodiment the pressure inside vacuum infusion tank can be adjusted to pressures in the range of 0.01 bar-1.5 bar, such as 0.01 bar-1.5 bar, such as 0.05 bar-1.5 bar, such as 0.05 bar-1 bar, such as 0.1 bar-1 bar, such as 0.05 bar-0.1 bar, such as 0.1 bar-0.3 bar, such as 0.3 bar-0.5 bar, such as 0.5 bar-0.7 bar, or such as 0.7 bar-0.9 bar. By having the possibility also to increase the pressure above 1 bar a larger pressure difference may be achieved following pressure release, which may result in a better vacuum infusion.

### Collection Tank

Following vacuum infusion the food product (now comprising probiotics) may require additional coatings, which is not vacuum-infused. Thus, in a further embodiment the vacuum infusion tank is further connected to a collection tank for passing the coated food product from the infusion tank to the collection tank, and wherein the collection tank is further connected to at least one vessel containing one or more substances to be applied to the collection vessel. Since not all solutions are suitable for being applied to a product through spraying, e.g. due to a high viscosity or because the solution comprises components which due to the size may clot the spraying nozzles other means for applying such solutions may be required. Furthermore, applying additional means for adding a solution to the vacuum infusion tank, may be inappropriate since high viscosity solutions may still result in damage to the spraying nozzles already positioned inside the vacuum infusion tank. The collection tank may receive a solution from one or more vessels by e.g. a standard tube, pipe or hose.

### Collection Tank Mixing Means

It may become difficult to get the one or more solutions evenly distributed on the vacuum infused food products. Thus, in yet a further embodiment the collection tank comprises at least one of the following means for mixing: a rotating impeller, a rotating mixing tank. The person skilled in the art would know of other means for mixing.

### Temperature Control

It is important to provide environmental conditions during the whole production, which are advantageously for the viability of the probiotics. Thus, in an embodiment at least the first storage tank and the first dosage tank comprise means for maintaining the temperature of the probiotic suspension in the range of 15° C. to 29° C. Probiotics are in general sensitive towards temperatures variations therefore control of temperature is advantageously. Furthermore, to provide products which have a constant viability count between different productions sessions, temperature control of at least some of the tanks which comprises probiotics may be an advantage.

It may be difficult to control the production plant manually, since it comprises many individual components. Thus, in a further embodiment the plant further comprises a control unit for controlling at least one of the activities selected from the group consisting of: controlling the temperature in at least one of the storage tanks, controlling the temperature in at least one of the dosage tanks, controlling opening and closing of inlets and outlets between two or more of the tanks, controlling the amount of liquid sprayed through the nozzles, controlling the pressure in the vacuum tank and controlling the mixing time.

### EXAMPLES

### Example 1

### Measuring the Viscosity of Selected Oils

Equipment: Dynamic rheometers Physica MCR 301 (Anton Paar GmbH, Germany), C-PTD200 Peltie temperature control and CC27 coaxial cylinder measuring system (in/out diameter 26.66 and 28.92 mm)

Method: The viscosity of the oils was measured at turning speed of 180 rpm; at temperature range of 5 to 50° C., heating rate was 0.5° C/min, viscosity was registered after each 1° C. Two parallels of samples were measured. The table of FIG. 1 lists the average viscosity (Pa·s) of the oils.

### UPP, Belgium Supplied:

1. Crude fish oil
2. Salmon oil A
3. Refined maize oil
4. Cod liver oil

### Vobra Special Petfoods BV, Netherlands Supplied:

5. Salmon oil B
6. Soybean oil (with antioxidant)
7. Sunflower oil (with antioxidant)
8. Linseed oil
9. Borage oil

Results: One of the oils, Salmon oil A (supplied by United Petfoods (UPP) Belgium), displays unique viscosity properties over the remaining oils tested in the present experiment. Although the viscosity of Salmon oil A at refrigerating temperatures is higher than the remaining fish oils, in the temperature range of range 20-25° C. Salmon oil A loose viscosity much faster with increasing temperature than the remaining oils tested. Accordingly, the change in the viscosity (ΔPa·s/° C.) Salmon oil A with temperature (within the temperature range 20-25° C.) of Salmon oil A is different from the remaining oils tested in the experiment. The change in the viscosity (ΔPa·s/° C.) of crude fish oil (supplied by United Petfoods (UPP) Belgium), cod liver oil (supplied by United Petfoods (UPP) Belgium) and salmon oil B (Vobra Special Petfoods BV, Netherlands) is basically the same within the temperature range of 20-25° C.

Salmon oil A was chosen as carrier oil (vehicle) for preparation of a probiotic/oil suspension for manufacturing a probiotic extrusion product by vacuum inclusion of the suspension. Salmon oil A was preferred over the remaining oils due to the unique viscosity properties in the temperature range 20-25° C. The manufacturing process is performed in temperature range 20-25° C. and the use of Salmon A oil will avoid the clotting of a spraying tip (nozzle) of a vacuum coater and improve homogenous distribution of probiotics in the carrier oil. Additionally oil/probiotic mixture is constantly mixed in the tank before introduction into a vacuum coater, thus formation of a probiotic flakes (non suitable for a vacuum coating) is avoided during the bacteria addition to the oil.

The viscosity of the analysed oils are equal at high temperatures (starting from 40° C.), but such high temperatures have severe effects on the viability of probiotic bacteria, and consequently on the CFU/kg of the final food product.

Taken together, viscosity of oils is influenced by the source of the oil and substances added to the oil. The substances added to the oil affects the properties of the oils such as the viscosity. Accordingly, the properties of the oil have to be taken into account when choosing an oil as a vehicle for infusion of probiotic micro-organism. Since, care should also be taken to ensure that the substances added to the oil in the preparation of the oil/probiotic suspension does not severely affect important parameters of the suspension such as the viscosity.

### Example 2

### Mixing of Probiotics and an Oil Solution to Obtain a Probiotic Suspension.

The suspension can be obtained by mixing one probiotic micro-organism, in a dry powder form having a total concentration of 10⁹-10¹⁶ CFU/kg dry powder, into an oil. The inclusion rate for the final suspension should be 0.3-15 kg of the probiotic powder per 100 kg oil. When the probiotics are mixed into an oil the probiotics may precipitate if the powder is not mixed slowly into to oil. Thus, not all of the freeze-dried powder should be added at once. To maintain the viability of the probiotics, the temperature of the suspension should not exceed 30° C. The mixing may be performed in a mixing tank, such as an IBC container, under continuously stirring. This mixing may be performed manually. Preferably the obtained suspension is transferred to a storage tank comprising mixing means. The transfer from the mixing tank to the storage tank is preferably done through a bottom outlet in the mixing tank into the storage tank (thus the mixing tank is physically positioned above the storage tank). The suspension is then mixed in the storage tank at a temperature of 15-29° C., not exceeding 30° C. (the mixing may be performed by rotation at 5-350 RPM) to obtain a suspension of homogenously dispersed probiotic micro-organism. The suspension should not be stored for longer than 3 hours in the storage tank before it is used in a vacuum infusion. If the suspension is stored for a longer time the suspension may become contaminated.

### Example 3

### Suspension/Oil Vehicle for Dog Food

The right choice of an oil as a probiotic compound carrier (oil vehicle) is based on the viscosity of the specific oil and the temperature which is needed to be implemented to achieve a particular viscosity. Together with the physical/chemical parameters of the oil which can have an influence on the viability of the probiotics, the organoleptic parameter of the specific oil also is a dramatic factor on an overall product taste and odor. In addition nutritional parameters also need to be considered. Thus, to find an oil vehicle which fulfils all these parameters is not an easy task.

### Organoleptic Parameters:

In case of a probiotic dog food, a suspension with a salmon oil carrier is used to produce an extruded dry dog food, the choice of the salmon oil was based on a fact that dogs eat for 90% with his smell and have a smell 30 times more than humans. Thus, it is very crucial to find the particular oil vehicle for a probiotic compound which will not have an influence on a palatability of the final product (dog food) based on a smell as major organoleptic parameter (especially for a dogs).

### Nutritional Parameters:

Together with above mentioned parameters, an oil used as an oil vehicle for probiotics needs to be “healthy”. High content of a saturated fatty acids, trans fatty acids and etc are generally considered as “unhealthy”. The high concentration of such fats furthermore minimizes the probiotic effect of the ready product and increases the risk of coronary heart disease by raising levels of “bad” LDL cholesterol and lowering levels of “good” HDL cholesterol. Salmon oil out of the animal fats is well known for its unique composition of poly unsaturated fatty acids (omega 3 and omega 6) and thus is generally considered as “healthy” fat.

To be able to provide a product having the above mentioned properties and the same be optimal for vacuum infusion it has been discovered that the viscosity of the oil vehicle is important.

### Viscosity:

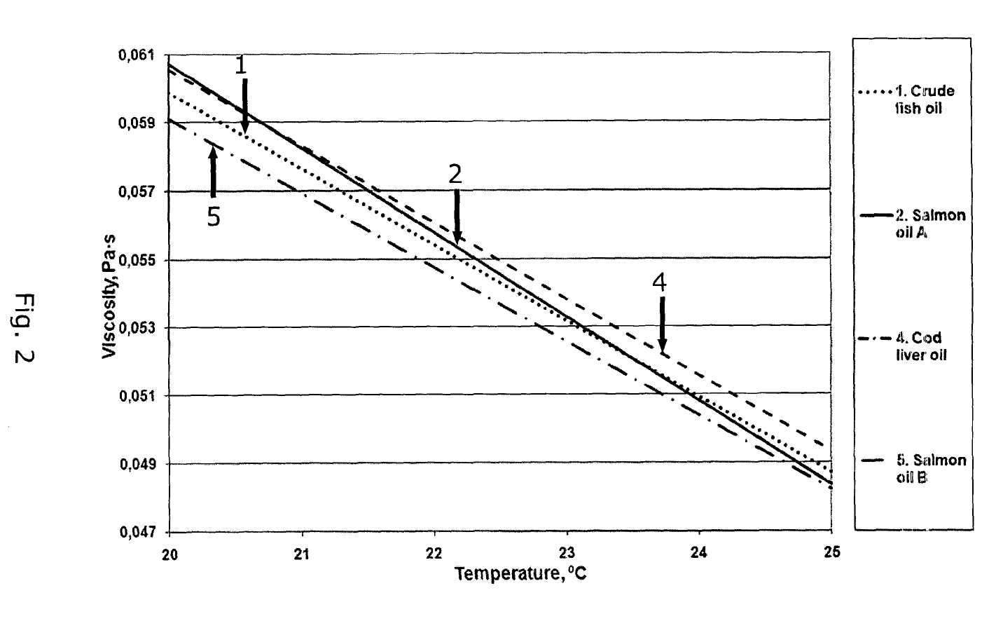

To find a salmon oil which also fulfils the criteria for being suited for vacuum infusion, viscosity of different salmon oils were compared. As shown in FIGS. 1 and 2 not all salmon oils have the same viscosity properties. The viscosity of salmon A decreases faster between 20° C. and 25° C. than does salmon oil B giving an extra advantage of usage of salmon oil A as a carrier (oil vehicle) of a probiotic compound. Salmon oils with such viscosity behaviour improve the mixing ability of the suspension together with equalized dispersal of the probiotic compound in the ready product and reduces sedimentation/wastes during the manufacturing stage with improvement of stability of the probiotic compound within the suspension and thus within the ready product.

Taken together salmon oil A becomes a suited oil vehicle for vacuum infusion of probiotics for animal food such as dog food.

It is to be understood that although the present example refers to dog food it does not mean that salmon oil A cannot be used in other animal products or human products.

### Example 4

### Oil Vehicle/Suspension for Human Food Products

The right choice of an oil as a probiotic compound carrier (oil vehicle) is based on the viscosity of the specific oil and the temperature which is needed to be implemented to achieve a particular viscosity. Together with the physical/chemical parameters of the oil which can have an influence on the viability of the probiotics, the organoleptic parameter of the specific oil also is a dramatic factor on an overall product taste and odor. In addition nutritional parameters also need to be considered. Thus, to find an oil vehicle which fulfils all these parameters is not an easy task.

### Organoleptic Parameters

Usage of animal fats/oils in a human product is limited because of the organoleptic parameters which can have an overall effect on a palatability of the ready product. Thus, such animal oils, like different type of fish oils, may lead to resistance by the end consumer towards such products, even if oil meets the health criterias (e.g. as described in example 3). Thus, the oil used as a probiotic oil vehicle in a human product needs to meet the viscosity criteria required for optimal vacuum infusion but with different organoleptic parameters than the oils used for animal products. Vegetable oils may be suitable candidates.

### Nutritional Parameters:

Instead of using animal oil it may be advantageous also to be able to have a suitable oil vehicle with vegetable origin. Several vegetable oils have positive health parameters. Linseed oil (Vobra Special Petfoods BV, Netherlands) compared with soy bean oil, maize oil and sunflower oil is considered as “healthy” oil with high concentration of poly unsaturated fatty acids (omega 3 and omega 6) and mild nutty taste. These parameters make linseed oil a suitable candidate as an oil vehicle for human product manufacturing.

### Viscosity:

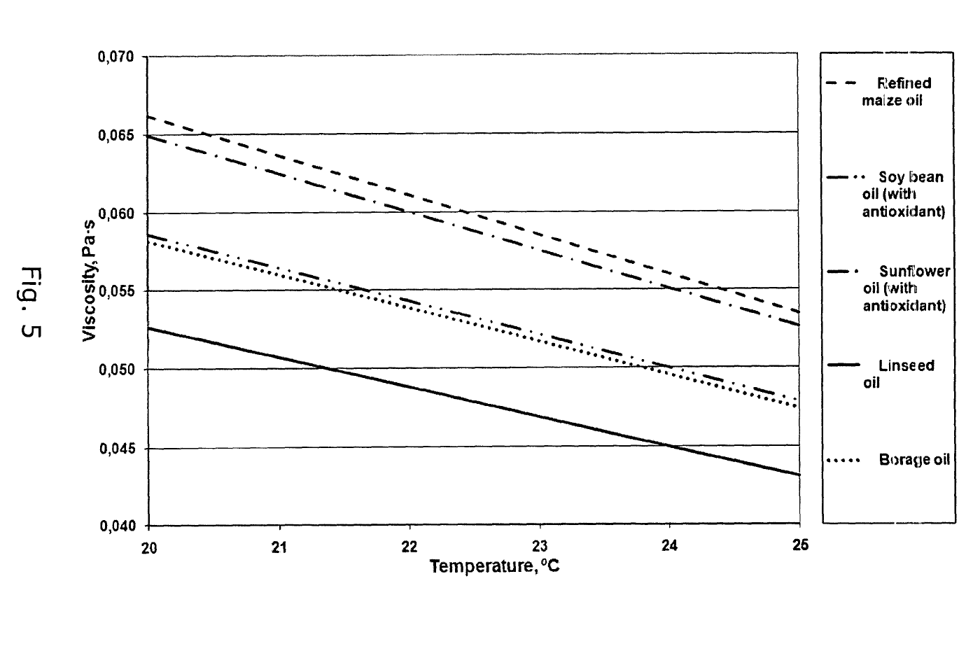

When comparing the viscosity of different oils with vegetable origin in the range of 20° C. and 25° C., it becomes apparent that linseed oil has unique properties for being used as an oil vehicle for vacuum infusion of probiotics (FIGS. 1 and 5). Linseed oil has the lowest viscosity at both 20° C. and 25° C. out of the vegetable oils analyzed. The curve of the linseed has got a small slope (low delta viscosity) but a low viscosity when compared to the other oils. Even when compared to the animal oils (FIGS. 1 and 4), linseed oils has the lowest viscosity at both 20° C. and 25° C.

Taken together, the viscosity of the linseed oil together with its unique physical/chemical and organoleptic parameters makes linseed oil a good candidate for usage as a probiotic oil vehicle for human product manufacturing.

It is to be understood that although the present example refers to human products it does not mean that linseed oil cannot be used in animal products.

### Example 5

### Viscosity of Suspension

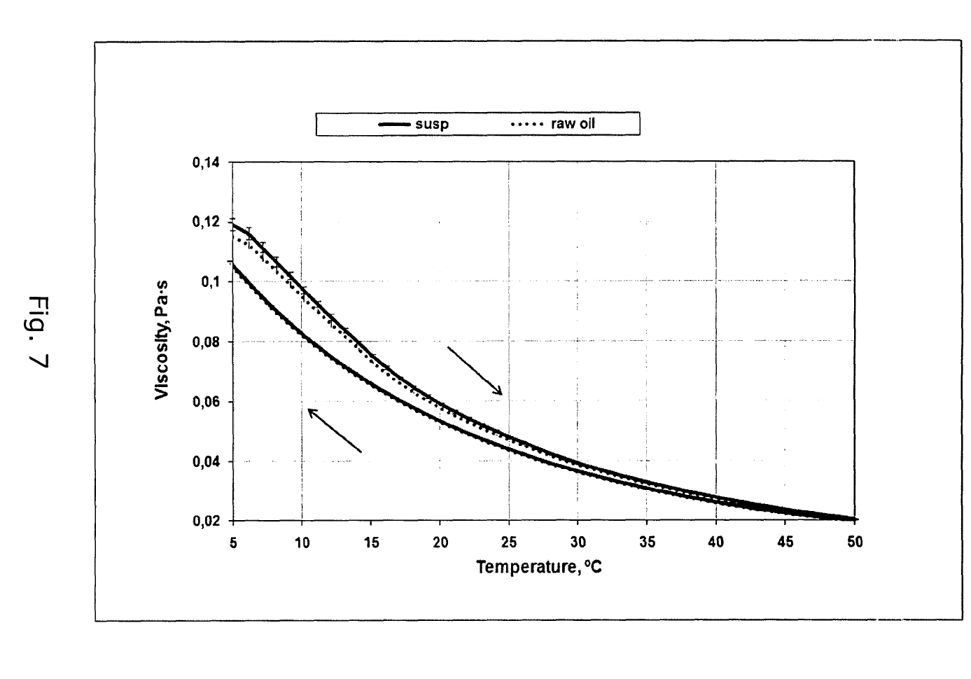

Since the viscosity of the final suspension is a key parameter when the suspension is going to be vacuum infused, the influence of the bacteria on the viscosity of the oil should be tested. FIG. 1 (lines 10-13) and FIG. 7 clearly show that the influence of the bacteria on the final viscosity at different temperatures is minimal. “Susp” (solid line) is salmon oil A with probiotics with a concentration/inclusion rate 1.2 kg/ton of final product. Raw oil (dashed line) is salmon oil A without probiotics. Top lines show the viscosity when the temperature is increased from 5-50C.° , whereas the bottom lines show the viscosity when the temperature is decreased from 50-5° C. In the bottom lines the dashed and solid lines are practically positioned on top of each other. The difference is between the cooling and heating is likely due to residual heat in the analyzed samples.

FIG. 1 (lines 10-13) shows the viscosity of the raw salmon oil vs suspension viscosity at heating from 5° C. to 50 ° C. and backwards cooling from 50° C. to 5° C. At current inclusion rate which was used the viscosity difference between both samples is minor with average of 0.001 Pa·s at each temperature step between both samples.

A visc. (20° C.-25° C.) of raw oil is 0.011 Pa·s at heating phase and 0.009 Pa·s at cooling phase.

A visc. (20° C. -25° C.) of suspension is 0.011 Pa·s at heating phase and 0.010 Pa·s at cooling phase.

Overall conclusion can be made that change of A visc. (20° C.-25° C.) of both samples at cooling and heating phases are minor and makes a 0.01 Pa·s in average.

In general there will be a difference between different measurements of the viscosity of a specific type of oil. This is likely due to the precise batch used and small variation in the way the samples are handled. Though such small variations are unavoidable the current invention clearly shows that the viscosity of the oil/suspension is indeed important for the viability of the probiotics in the final product.

### Example 6

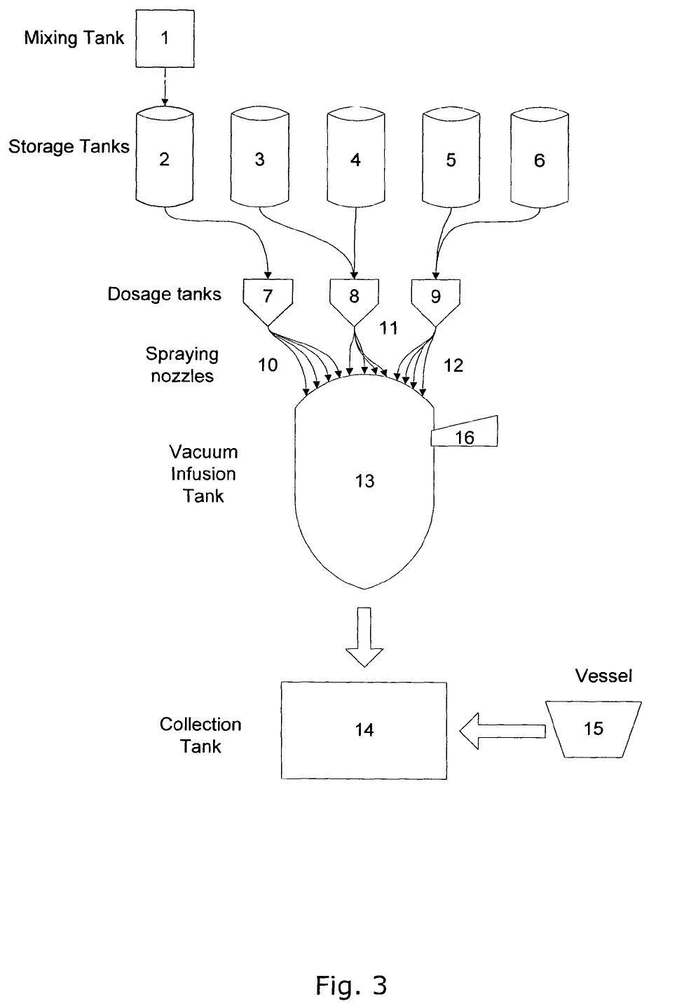

### Production Plant, Reference to FIG. 3.

The plant may comprise one or more storage tanks 2-6 which can be used to store individual solutions, such as a probiotic suspension, a solution of fat, and a solution of digest. The storage tank 2 may be further connected to a mixing tank 1. The reason is that mixing of an oil/fat suspension with a freeze-dried probiotic powder, may result in precipitation of the probiotics if the powder is not mixed slowly into to oil/fat suspension. This mixing may be performed manually. The mixing tank 1 may be physically positioned above the storage tank 2. In this way the suspension in the mixing tank 1 may be transferred to the storage tank 2 through an outlet positioned at the bottom of mixing tank 1. Alternatively, the outlet may be positioned otherwise such as on side of the mixing tank 1. The mixing tank may be adapted to allow emptying the tank from e.g. an outlet positioned on side of the mixing tank 1.

Furthermore, this setup means that the transfer can be performed only by the force of gravity, which may be beneficial for the viability of the probiotics in the suspension.

The storage tank 2 and the dosage unit tank 7 for storing and dosing a probiotic suspension may comprise means for mixing the suspension such as an impeller or a rotational tank or a combination of both. The other storage and dosage tanks may comprise similar means for mixing. Each of the storage tanks 2-6 may then be further connected to individual dosage tanks 7-9. In another embodiment, at least two storage tanks share a dosage tank. Each of the dosage tanks 7-9 may then be further connected to a single vacuum infusion tank 13. In one embodiment these connections comprise at least one spaying nozzle connecting each dosage individually to the vacuum infusion tank 13. In a further embodiment, these connections are sets of spraying nozzles 10-12 connection each dosage tank individually to the vacuum infusion tank 13, allowing for spraying the content of each of the dosage unit tanks individually on the food products present in the vacuum infusion tank 13. This is important to avoid mixing of the oil/fat suspension comprising probiotics with one or more of the other solutions, since intermixing may lower the viability of the probiotics. Thus, at least the spraying nozzles leading from the probiotic-oil/fat suspension to the vacuum infusion tank should not be connected to any of the other dosage tanks.

The precise shape of the spraying nozzles may vary, since the form and shape of the nozzles have to be optimized to the solution/suspension which is going to be sprayed through the nozzles. The vacuum infusion tank 13 may furthermore comprise one or more openings 16 for receiving a food product. When the food product is in place in the tank the following steps may take place:
a) reduction of the pressure in the vacuum infusion tank to 0.2-0.95 bar,
b) introducing one of the solutions from one of the dosage unit tanks 7-9 through the corresponding one or more sets of spraying nozzles 10-12 at e.g. a temperature of 15-29C,
c) restore pressure to 1 bar,
   Steps a)-c) may then be repeated with other solutions (or the same solution) to further vacuum infusions into the food product. This is important for getting the subsequent solutions infused into the product. The release of the vacuum may be performed slowly to avoid abrupt changes in pressure which may be harmful to the product and/or the probiotics.

Some vacuum tanks are designed to release the pressure in the vacuum tank using an inert gas, which may actually be effect the stability of fats and thus be harmful for the viability of the probiotics. Thus, in an embodiment the pressure release is not performed with an inert gas such as nitrogen and carbondioxide. It is to be understood that release of the pressure using atmospheric air is part of the invention though atmospheric air comprises nitrogen and carbondioxide.

To get the sprayed solutions evenly distributed in the infusion tank some kind of mixing may be required. Thus the mixing tank may be able to rotate or comprise an impeller or the like. Therefore it may be advantageously if the mixing is performed during the inclusion steps or after each step of ingredient(s) inclusion (in vacuum infusion tank 13).

The vacuum infusion tank may also comprise an outlet leading to a collection vessel 14. The collection tank 14 may be particular useful, when a coating is also required on the food product (which is not going to be vacuum infused). Such a coating may be stored in a vessel 15 connected to the collection tank 14. Examples of coatings could be suspensions comprising honey, natural sweeteners, artificial sweeteners, vitamins, tartar or other additives or the like.

### REFERENCES

Official Journal of the European Union, COMMISSION REGULATION (EC) No 1520/2007 of 19 Dec. 2007

1. A suspension for vacuum infusion of an extruded probiotic food product, wherein said suspension comprises a vegetable oil and at least one probiotic micro-organism in the concentration of 10⁶-10¹⁶ CFU/kg of said vegetable oil, and said suspension having a dynamic viscosity of less than 0.08 pascal-second (Pa·s) at 20° C.

2-35. (canceled)

36. The suspension according to claim 1, wherein the peroxide level of said oil is not more than 2 meq O₂/kg.

37. The suspension according to claim 1 further comprising an antioxidant.

38. The suspension according to claim 37, wherein said antioxidant is selected from the group consisting of natural antioxidants and synthetic antioxidants.

39. The suspension according to claim 38, wherein said natural antioxidant is an antioxidant selected from the group consisting of flavanoids, cartonoids, tocotrienol, tocopherol and terpenes.

40. The suspension according to claim 39, wherein the antioxidant is astaxanthin.

41. The suspension according to claim 38, wherein the antioxidant is selected from the group consisting of BHA and BHT.

42. The suspension according to claim 1, wherein the vegetable oil is rich in unsaturated fatty acids.

43. The suspension according to claim 42, wherein the unsaturated fatty acids are n-3 fatty acids and/or n-6 fatty acids.

44. The suspension according to claim 1, wherein the oil is selected from the group consisting of linseed oil, olive oil, borage oil, lin oil, camelina oil, grape seed oil, chia oil, kiwifruit seeds oil, perilla oil, lingonberry, purslane oil, seabuckthorn oil, hemp oil and soybean oil.

45. The suspension according to claim 1, wherein the at least one probiotic micro-organism is selected from the group consisting of bacteria, yeast and mold.

46. The suspension according to claim 45, wherein said at least one probiotic micro-organism is bacteria selected from the group consisting of Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus.

47. The suspension according to claim 46, wherein said at least one probiotic micro-organism is Enterococcus faecium.

48. The suspension according to claim 46, wherein said at least one probiotic micro-organism is the NCIMB 10415 strain of Enterococcus faecium.

49. The suspension according to claim 45, wherein said at least one probiotic is a yeast selected from the group consisting of Saccharomyces, Debaromyces, Candidaw Pichia and Torulopsis.

50. The suspension according to claim 45, wherein said at least one probiotic is a mold selected from the group consisting of Aspergillus, Rhizopus, Mucor, and Penicillium and Torulopsis.

51. The suspension according to claim 45, wherein the probiotic micro-organism is selected from the group consisting of Aspergillus niger, A. oryzae, Bacillus coagulans, B. lentus, B. licheniformis, B. mesentericus, B. pumilus, B. subtilis, B. natto, Bacteroides amylophilus, Bac. capillosus, Bac. ruminocola, Bac. suis, Bifidobacterium adolescentis, B. animalis, B. breve, B. bifidum, B. infantis, B. lactis, B. longum, B. pseudolongum, B. thermophilum, Candida pintolepesii, Clostridium butyricum, Enterococcus cremoris, E. diacetylactis, E. faecium, E. intermedius, E. lactis, E. muntdi, E. thermophilus, Escherichic coli, Kluyveromyces fragilis, Lactobacillus acidophilus, L. alimentarius, L. amylovorus, L. crispatus, L. brevis, L. casei L. curvatus, L. cellobiosus, L. delbrueckii ss. bulgaricus, L farciminis, L. fermentum, L. gasseri, L. helveticus, L. lactis, L. plantarum, L. johnsonii, L. reuteri, L. rhamnosus, L. sakei, L. salivarius, Leuconostoc mesenteroides, P. cereviseae (damnosus), Pediococcus acidilactici, P pentosaceus, Propionibacterium freuclenreichii, Prop. shertnanii, Saccharontyces cereviseae, Staphylococcus carnosus, Staph. xylosus, Streptococcus infantarius, Strep. Salivarius ss. thermophilus, Strep. thermophilus, Strep. lactis.

52. The suspension according to claim 1, wherein the dynamic viscosity of said suspension is less than 0.06 pascal-second (Pa·s) at 20° C.

53. The suspension according to claim 1, wherein the dynamic viscosity of said suspension is in the range of 0.04 to 0.06 pascal-second (Pa·s) at 20° C.

54. The suspension according to claim 1, wherein the suspension has a Δ Pa·s between 20° C. and 25° C. of at least 0.009 Pa·s.

55. A method of preparing a probiotic suspension comprising:
a) providing at least one probiotic micro-organism in a dry powder form having a total concentration of 10⁹-10¹⁷ CFU/kg dry powder;
b) providing a vegetable oil;
c) adding 0.3 to 15 kg of said probiotic micro-organism powder per 100 kg oil to said vegetable oil in an container while continuously stiffing to make a suspension premix;
d) transferring the suspension premix of c) to a storage tank that comprises a mixer with the proviso that the transfer is not by vacuum suction;
e) mixing said premix suspension to obtain a suspension of homogenously dispersed probiotic micro-organism; and
f) obtaining said suspension.

56. The method according to claim 55, wherein the total concentration of the at least one probiotic micro-organism in said dry powder form is in the range of 10¹⁰ to 10¹³ CFU/kg dry powder.

57. The method according to claim 55, wherein 3.3 to 6.7 kg of said probiotic micro-organism powder per 100 kg is added to said vegetable oil in the container.

58. The method according to claim 55, wherein said premix is mixed for no more than 3 hours.

59. The method according to claim 55, wherein said premix is mixed for not less than 1 hour.

60. A method of producing an extruded food product comprising at least one probiotic micro-organism, comprising:
providing a suspension that comprises at least one probiotic micro-organism; and
incorporating said suspension into a food product by vacuum, wherein said probiotic micro-organism is homogenously distributed throughout the structure of the food.

61. The method according to claim 60, wherein said food product is a pet food product.

62. The method according to claim 60, wherein said food product is a human food product.

63. An extruded probiotic food product obtained by a method according to claim 55.

64. The food product of claim 63, wherein the minimal amount of the probiotic in the product is in the range of 10⁵ CFU/Kg to 10¹⁵ CFU/Kg.

65. The food product of claim 63, wherein percentage of moisture of the product is above 7%.

66. A method of using a probiotic suspension for the preparation of a extruded probiotic food product comprising:
providing the suspension of claim 1, wherein said suspension comprises an vegetable oil and at least one probiotic micro-organism in the concentration of 10⁶-10¹⁶ CFU/kg of said vegetable oil and said suspension having a dynamic viscosity of less than 0.08 pascal-second (Pa·s) at 20° C.; and
incorporating said suspension into a food product.
